(19) United States
(12) Patent Application Publication
(10) Pub. No.: US 2004/0091570 A1
(43) Pub. Date: May 13, 2004

(54) Linear drive device for opening and closing molding tools and for applying a closing force thereon

(76) Inventors: Walter Wohlrab, Weissenburg (DE); R?uuml;diger Ostholt, Wetter (DE); Ralf Ingo Meyer, Hagen (DE); Klaus Becker, Wetter (DE)

Correspondence Address: HENRY M FEIEREISEN, LLC, 350 FIFTH AVENUE, SUITE 4714, NEW YORK, NY, 10118, US

(21) Appl. No.: 10/470,026

(22) PCT Filed: Jan. 24, 2002
(86) PCT No.: PCT/EP02/00724

(30) Foreign Application Priority Data
Jan. 30, 2001 (DE) 101 03 983.2
May 8, 2001 (DE) 101 22 260.2

(51) Int. Cl. B29C 45/66

(52) U.S. Cl. 425/589; 425/595

(57) ABSTRACT

The invention relates to a linear drive device for opening and closing molding tools and for applying a clamping force thereon, especially mold halves of a plastics molding machine. The device is comprised of a screw drive acting upon the molding tool, a first screw nut for opening and closing the molding tools and a piston/cylinder unit for applying a clamping force. In order to provide a linear drive device for opening and closing molding tools, especially mold halves of a plastics molding machine, which enables fast opening and closing of the molding tools and energy-optimized application of the clamping force to the molding tools, the piston/cylinder unit (113) acts upon the molding tool by means of a second screw nut (108).

The invention relates to a linear drive device for opening and closing molding tools as well as applying a clamping force thereon, in particular of mold halves of a plastics molding machine, according to the preamble of claim 1.

European patent application EP 0 976 521 A1 discloses a clamping device for platens of an injection molding machine. The injection molding machine includes a fixed platen as well as a movable platen, with each of their confronting sides carrying a mold half. The fixed platen is connected to an equally fixed clamping plate via four tie bars, which are arranged in the corners of an imaginary tetragon. The moving platen is movable along the tie bars between the fixed platen and the clamping plate. Secured to the side facing away from the mounting area for the molding tool is a ram which implements the movement of the shiftable platen and extends in direction of the stationary clamping plate as well as therethrough. An electromotive drive acts upon the ram to implement the movement of the moving platen along the tie bars, i.e. for opening and closing the molding tools. After closing the molding tools, the clamping force is applied upon the mold halves via a hydraulic piston/cylinder unit which also acts upon the ram.

The electromotive drive is configured as screw drive, whereby the ram is designed as hollow axle with an internal thread for a screw.

The piston/cylinder unit includes an annular piston through which the screw is guided and which is connectable to the outer side of the ram via a coupling for application of the clamping force. The annular piston is guided in a cylinder space, which is also ring-shaped and configured in the clamping plate, and thus movable in substantially parallel relationship to the ram. In order to enable also an opening of the mold halves after the executed injection process, the piston/cylinder unit is of double-acting design.

The coupling between the piston/cylinder unit and the outer circumferential surface of the ram is realized via an outer toothing on the circumferential surface of the ram and a complementary inner toothing on the inner circumferential surface of the opening of the annular piston. Viewed in circumferential direction, the inner toothing and also the outer toothing are breached several times by grooves which are evenly distributed on the circumference in parallel relationship to the longitudinal extension of the ram. Thus, a rotation of the piston of the piston/cylinder unit inside the cylinder space results in an engagement of the teeth of the inner toothing with the teeth of the outer toothing, and a rotation in opposite direction results in a positioning of the inner toothing and outer toothing in the respective groove of the inner toothing and outer toothing so that the ram is disengaged from the piston. The required rotation for the coupling operation is provided by a further piston/cylinder unit or a servomotor.

Although this European patent application does already disclose the combined hydraulic and electromotive drive of the ram of a moving platen of an injection molding machine, the configuration of the coupling with inner toothing and outer toothing, each having grooves extending in longitudinal direction of the screw, enables, however, only an engagement or disengagement in particular discrete movement or rotation positions of the screw. Thus, it is required to terminate the clamping motion of the molding tools in dependence on the position of the screw in order to, in fact, enable an engagement of the inner toothing in the outer toothing. Subsequently, the remaining closing motion of both molding tools must be carried out via the piston/cylinder drive. This entails the drawback of an increase in the required stroke of the piston/cylinder unit and in an accompanying enlargement of the required oil volume.

EP 0 381 107 B1 discloses moreover a clamping unit with a ball screw drive for implementing the opening and closing motions of the moving platen, whereby the ball screw drive is respectively mounted to the ends of tie bars which connect the platens, with the ends configured as screws. The clamping force is hereby generated by a hydraulic piston/cylinder unit arranged in one platen, whereby the clamping pressure is respectively borne by the ball screw drives respectively arranged at the ends of the tie bars. In view of the fact that the support of the significant clamping forces is established constantly via the balls of the ball screw drive and thus substantially via only point-like contact areas between balls and threaded grooves, the ball screw drive is subject to significant loads. Although the ball screw drive has shown its effectiveness to execute rapid adjustment motions at a small load, it is less suitable to withstand the extreme high clamping forces of an injection molding machine in case of a static load.

The present invention is based on the object, to provide a linear drive device for opening and closing molding tools, in particular mold halves of a plastics molding machines, to enable a rapid opening and closing of the molding tools and an energy-optimized application of the clamping force upon the molding tools.

This object is attained by a linear drive device for opening and closing molding tools as well as applying a clamping force thereon, in particular mold halves of a plastics molding machines, having the features of claim 1. Advantageous configurations of the invention are set forth in claims 2 to 28.

In accordance with the invention, a linear drive device for opening and closing molding tools as well as applying a clamping force thereon, in particular mold halves of a plastics molding machines, has a screw drive acting on the molding tools and including a first screw nut for opening and closing the molding tools, a screw, and a piston/cylinder unit acting on the molding tools for applying the clamping force, and realizes through association of the piston/cylinder unit to a second screw nut that the clamping forces, which are fairly high in relationship to the required forces for opening and closing the molding tools, are prevented from introduction into the first screw nut, so that the first screw nut can be best suited to the requirements for opening and closing the molding tools. The use of a second screw nut for the transmission of the clamping forces, after executed closing motion of the molding tools via the screw drive, enables a coupling of the screw with the piston/cylinder unit in any position of the screw and not only in discrete screw positions. The stroke travel of the piston/cylinder unit can thus be minimized and the required amount of pressure medium can accordingly be minimized for the circulation.

It is especially advantageous, when the second screw nut is moved along the screw during opening and closing of the molding tools via the first screw nut with little force, preferably freewheeling, so as to maintain its proximity on the screw to the first screw nut and to the stationary piston/cylinder unit. Hereby, the screw includes a thread for the second screw nut whose thread groove is wider than the width of thread teeth of the second screw nut. Preferably, the screw is connected in the form of a ram fixed with the molding tool, i.e. with its platen, so that the screw nuts alone represent the rotating components to be driven.

The linear drive device is constructed in an especially simple and compact manner when the screw is double-threaded to have in addition to the thread for the second screw nut a further thread for the first screw nut. Advantageously, the first screw nut and the pertaining thread are designed as ball screw drive, and the second screw nut and the pertaining thread are configured as flat screw drive, preferably as acme screw drive. The ball screw drive is characterized by high travel speeds with little noise and loss, by a slight friction resistance, and a high positional accuracy. The flat screw drive is preferably self-locking so as to assist in maintaining the clamping force.

In accordance with a structurally especially compact construction, the piston/cylinder unit includes essentially a piston and a cylinder space in a housing, whereby the annular piston has a sleeve-like ram through which the screw is guided. The second screw nut is supported adjacent to the sleeve-like ram and via rolling-contact bearings in a sleeve-like collar arranged at the housing. The second screw nut is hereby movably configured for transmission of the clamping force from the ram onto the screw in longitudinal direction of the screw.

The torque can be transmitted in a particularly simple manner from the second screw nut to the first screw nut by arranging the first screw nut on the screw at a slight distance next to the second screw nut, and interconnecting the first and second screw nuts via coupling elements. The second screw nut is hereby movable in relation to the first screw nut in longitudinal direction of the screw in order to decouple the first screw nut from the clamping force, when the piston/cylinder unit is actuated and the second screw nut is moved hereby.

In a constructively simple manner, the coupling elements are configured as pins, each of which having ends respectively inserted in bores in the confronting end surfaces of the first screw nut and the second screw nut. The depth of the bores and the length of the pins are so selected that, as described above, the second screw nut is movable in relation to the first screw nut in longitudinal direction of the screw.

Advantageously, the first screw nut is supported via spring elements on the second screw nut, so that the ball screw drive cannot be overly stressed by the clamping force. The spring elements are configured advantageously as disc springs and thus are space-saving and arranged between the first screw nut and the second screw nut.

The drive of the second screw nut and thus of the first screw nut for opening and closing the molding tools is implemented via a crown gear arranged on an end surface of the second screw nut and driven by a belt.

Preferably, the piston/cylinder unit can be driven hydraulically.

According to a further separate embodiment of the linear drive device of the invention, the screw is realized as hollow shaft and the first screw nut is arranged in fixed rotative engagement to one end of the screw. In addition, a further screw is provided for opening and closing of the molding tool and extends through the first screw nut into the screw. The configuration of the screw as hollow shaft is advantageous to increase the transmittable buckling forces. In order to move the second screw nut during opening and closing of the molding tool via the further screw along the first screw, and to transmit the torque transmission from the driven second screw onto the further shaft, the further screw is connected via a shaft in parallel relationship thereto and belt drives with the second screw nut.

According to the invention, there is the further advantage that when the closing process realized by the ball screw drive is over and the clamping force is initiated by the clamping unit, the first screw nut can rotate back automatically as soon as the clamping force is effective, without need for geared holding brakes which are operated separately and provide discrete switching sequences, whereby temperature-based deformations of the clamping unit, as encountered during initial operation of the injection molding machine, are of no consequence.

Preferably, the engagement means for ensuring the force transfer from the screw to the second screw nut via a long line contact are implemented by a helix so that the force transfer is no longer realized via individual point-like ball contact areas but via a line contact area extending several times about the circumference of the helix.

Exemplified embodiments of the present invention will now be described in more detail with reference to the drawings, in which:

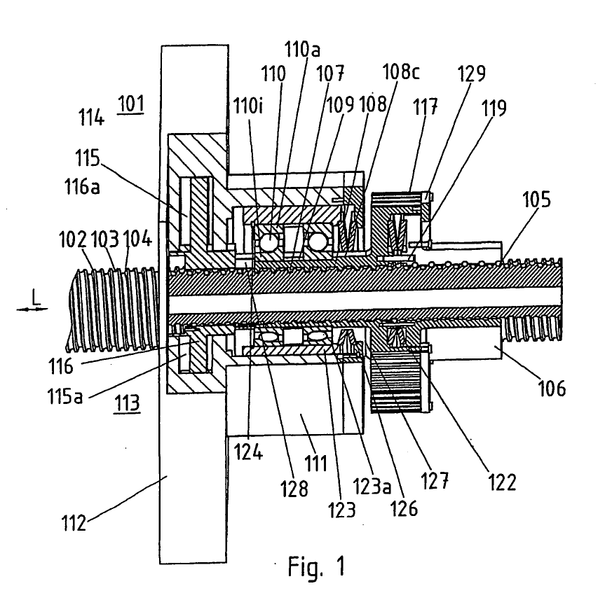

FIG. 1 shows a schematic sectional view of a first embodiment of a linear drive device;

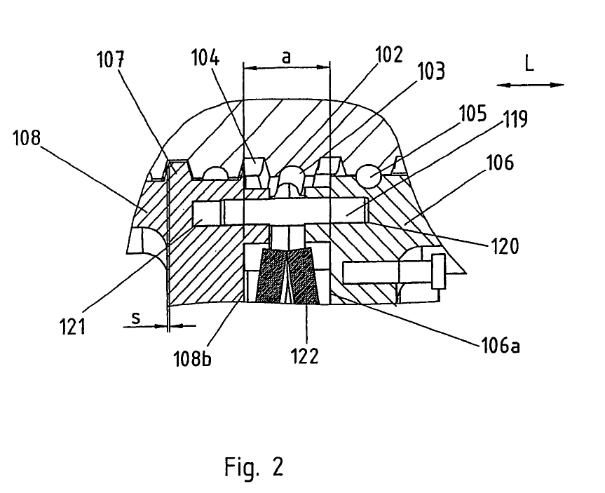

FIG. 2 is a detailed illustration, on an enlarged scale, of FIG. 1 in an area of two adjacent screw nuts of the linear drive device;

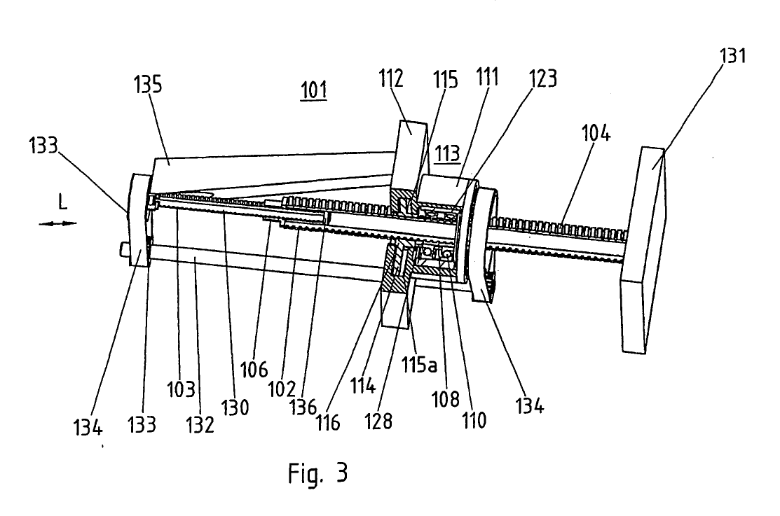

FIG. 3 is a schematic perspective illustration of a second embodiment of a linear drive device;

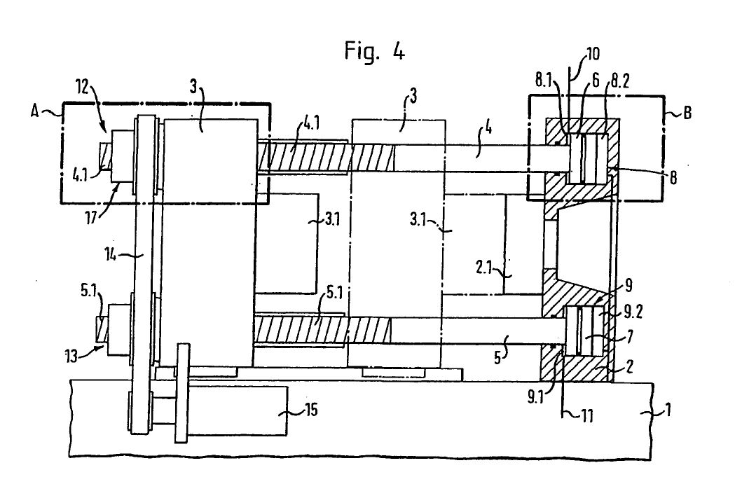

FIG. 4 is a basic illustration of a clamping unit of an injection molding machine having incorporated therein another embodiment of a linear drive device according to the invention;

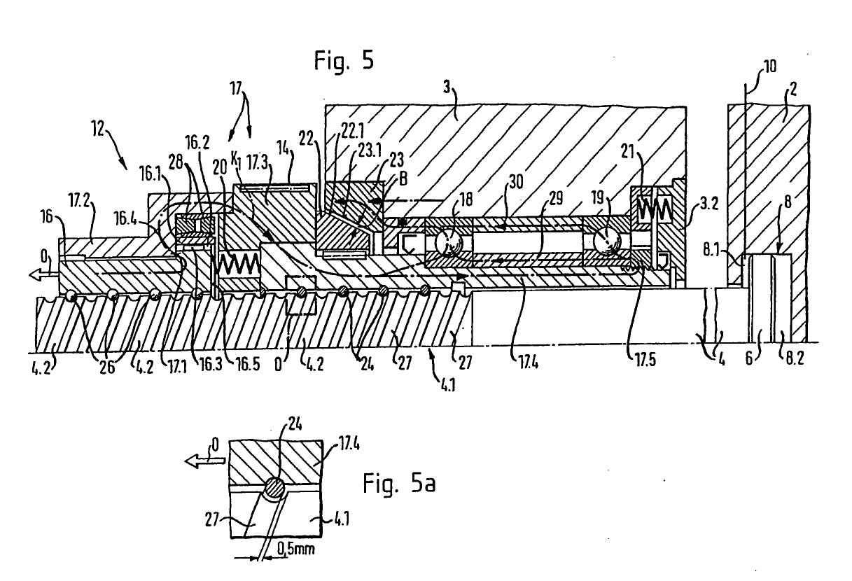

FIG. 5 is a half-section of the partial areas, marked A and B in FIG. 4, on an enlarged scale, with the screw drive during opening motion;

FIG. 5a is a detailed illustration of area D of FIG. 5;

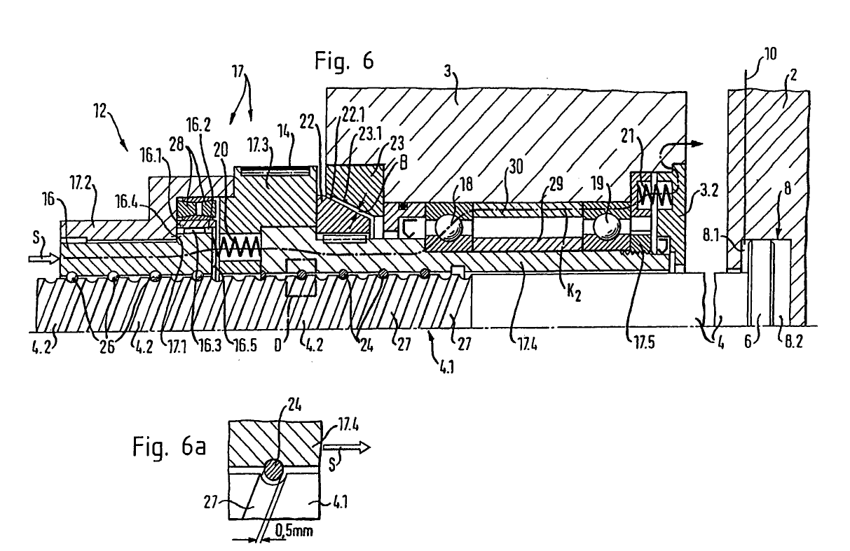

FIG. 6 is the illustration according to FIG. 5 with the screw drive during closing motion;

FIG. 6a is a detailed illustration of area D of FIG. 6;

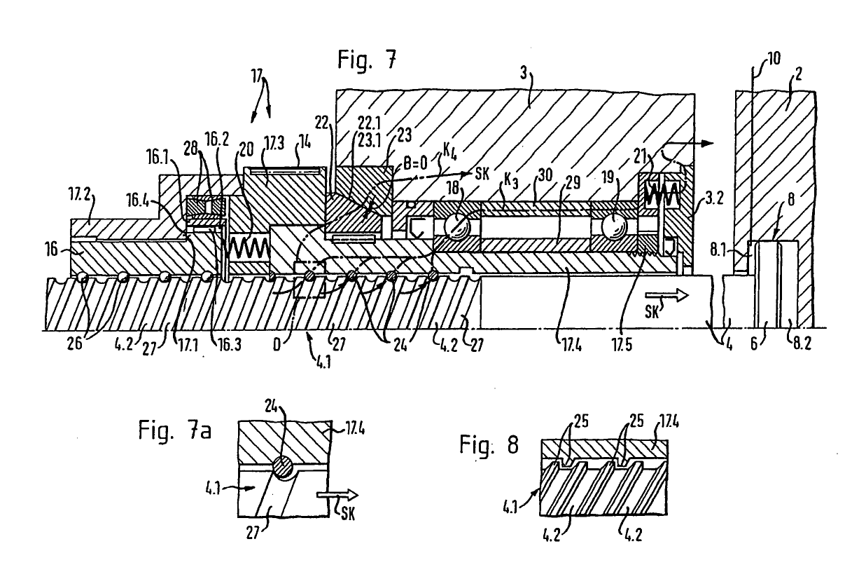

FIG. 7 is the illustration according to FIG. 5 with the screw drive and the clamping force unit during application of a clamping force;

FIG. 7a is a detailed illustration of FIG. 7; and

FIG. 8 is an alternative embodiment of the engagement means according to FIGS. 5a, 6a, 7a, with thread profiles in the form of an acme thread.

FIG. 1 shows a schematic cross section view of a linear drive device 101 of a plastics molding machine in the form of an injection molding machine. The linear drive device 101 includes a screw 102, shown by sections and having a left end connected securely to a not shown platen of an injection molding machine to assume the function of a ram. Mounted to the opposite side of the platen is a mold half. The injection molding machine is thus constructed as a so-called three-platen machine. Of course, the injection molding machine may also be constructed as so-called two-platen machine, whereby the screw is subject to tensile forces in the clamping position.

The screw 102 is double-threaded and thence provided on its outer circumferential area with a first thread 103 and a second thread 104. The first thread 103 is configured as a helical track which is wound about the screw 102 for receiving balls 105 of a ball screw drive with a screw nut 106 designed as ball screw nut. The ball screw drive comprised of the first thread 103, the balls 105 and the first screw nut 106 provides a rapid movement of the screw 102 in the longitudinal direction L and thus for opening and closing the molding tools for which a small axial force is required in comparison with the clamping force for the mold halves.

The second thread 104 is configured as acme thread having a thread groove for engagement of the teeth 107 of a second screw nut 108. As a consequence of the double-threaded construction of the screw 2, both threads 103, 104 have a respectively great pitch. The width of the revolving thread tooth 107 of the screw nut 108 is configured with a smaller width in comparison to the normal acme thread, so as to provide a clearance S (see FIG. 2) between the flanks of the thread groove of the screw 102 and the tooth 107 of the second screw nut 108 in longitudinal direction L of the screw 102. The clearance S amounts for each side of the tooth 107 about 2/10 to 10/10 mm, in particular 5/10 mm. The second screw nut 108 is not in contact with the thread groove of the second thread 104 of the screw 102 during rapid stroke of the screw via the first screw nut 106.

The second screw nut 108 is supported on its outer circumferential surface via a pair of rolling-contact bearings 110, preferably via single-row angular ball bearings, upon the inside of a sleeve-shaped collar 111 of a housing 112. This housing 112 is connected to a not shown machine frame of the plastics molding machine for transmission of the movement forces for the rapid stroke of the screw 102 for opening and closing of the molding tools and the application of the clamping force via the screw 102 onto the not shown molding tools. In the area of their inner and outer rings 10i and 10a, both rolling-contact bearings 110 are supported in spaced-apart relationship by rings 109 which are disposed in concentric relationship to the screw 102.

The outer rings 110a of the rolling-contact bearings 110 are supported by a sleeve 123 in the collar 111 of the housing 112. The outer ring 110a of the right rolling-contact bearing 110 is supported by a shoulder 123a of the sleeve 123. The outer ring 110a of the opposite left rolling-contact bearing 110 is supported via a securing ring 124 on the sleeve 123. The sleeve 123 is movable against a further spring element 126 in longitudinal direction L of the screw 102 in the collar 111 of the housing 112 by a stop 125, which is disposed on the end of the collar 111 confronting the housing 112. The spring element 126 is configured as disc spring and supported, on one hand, on the end surface of the sleeve 123, facing away from the housing 112, and, on the other hand, on a further stop 127 which has a ring-shaped configuration and is joined to the open end of the collar 111.

The inner ring 110i of the right rolling-contact bearing 110 is supported on a shoulder 108c of the second screw nut 108. On the opposite side, the inner ring 110i of the left rolling-contact bearing 110 bears upon a distance ring 128 which is disposed adjacent to the end surface 108b of the second screw nut 108 on the screw 102.

The housing 112 is comprised in addition to the collar 1111 essentially of a piston/cylinder unit 113 with a ring-shaped piston 114 and a correspondingly ring-shaped cylinder space 115. The ring-shaped piston 114 has an inner opening for connection to a sleeve-shaped ram 116 through which the screw 102 is guided and which has an inner circumferential surface at a clearance to the outer circumferential surface of the screw 102. The outer circumferential surface of the sleeve-shaped ram 116 is sealed against the inner circumferential surface of the circular opening of the cylinder 115 and is movable in longitudinal direction L of the screw 102 and thus toward the lateral end surface 108a of the second screw nut 108, when the cylinder 115 is subjected to pressure.

Disposed on the ram 116 distal end surface 108b of the second screw nut 108 for carrying out the rapid stroke is a crown gear 117 which is disposed in concentric relationship to the second screw nut 108 and connected by a belt 118 with a not shown electric motor.

As shown in particular in FIG. 2, which shows a detail, on an enlarged scale, of FIG. 1 in the area of the adjacent screw nuts 106 and 108, a coupling element 119 is disposed between the crown gear 117 or the second screw nut 108 and the first screw nut 106, which are arranged at a distance a of about 1 cm on the screw 102, for realizing a fixed rotative transfer of the torque from the crown gear 117 or the second screw nut 108 upon the first screw nut 106. The coupling elements 119 are constructed as pins which are inserted in respective bores 120 in the end surface 106a of the first screw nut 106, facing the second screw nut 108, and with their free end inserted in further bores 121 in the end surface 108b of the second screw nut 108, whereby the depth of the bores 121 is so selected that the first screw nut 106 is able to move in longitudinal direction L toward the second screw nut 108 as the distance a decreases. The distance a is determined by the clearance S and the structural width of the spring element 122.

Further disposed in the area of the coupling elements 119 between the first screw nut 106 and the crown gear 117 or the second screw nut 108 are spring elements 122 which are preferably constructed as disc springs. The spring elements 122 are provided to realize, on one hand, a support of the first screw nut 106 on the second screw nut 108 and thus on the housing 106 during rapid stroke action, and, on the other hand, a decoupling of the travel motion of the second screw nut 108 during application of the clamping force from the first screw nut 106.

The mode of operation of the present invention will now be described in more detail with reference to a clamping process of the molding tools of an injection molding machine. Starting from opened mold halves, a rapid stroke is first required to close the molding tools. Thus, the not shown electric motor is operated for driving the crown gear 117 via the belt 118. The crown gear 117, which is fixedly connected to the second screw nut 108, drives therefore, on one hand, the second screw nut 108, which is supported via rolling-contact bearings 110 in the collar 111 of the housing 123, and, on the other hand, also the first screw nut 106 via the pin-shaped coupling elements 119. The first screw nut running counterclockwise to the left is supported in longitudinal direction L of the screw 102 by the end surface 108b of the screw nut 108 via the spring elements 122. These support forces are transmitted to the second screw nut 108 via their rolling-contact bearings 110, via the sleeve 123, the stop 125 of the housing 112, the housing 112 and thus onto the machine frame. Thus, the forces required for a rapid stroke of the screw 102 are transmitted via the first screw nut 106, revolving to the left—as viewed in longitudinal direction L of the screw 102—onto the first thread 103 of the screw 102 via the balls 105, so that the screw 102 is moved in its longitudinal direction L linearly to the right. This drive by means of the first screw nut 106 of the screw 102 is continued until the mold halves are brought in slight contact or just shy of this point in time. The drive is then stopped via the belt 118.

The clamping force required now for pressing the mold halves together and, optionally, for final closing of both molding halves is then implemented by the piston/cylinder unit 113. Admission of pressure oil into the right cylinder compartment 115a results in a movement of the piston 114 and the attached ram 116 to the right, and the right free end surface of the ram 116 contacts via the distance ring 128 the right end surface 108a of the second screw nut 108 and moves the second screw nut 108, which is axially movably received in the collar 111, together with the rolling-contact bearings 110 and the sleeve 123 to the right in longitudinal direction L of the screw 102 and thus within the sleeve shaped collar 111 of the housing 112.

As a consequence, the clearance S between the flanks of the thread groove of the second thread 104 and the thread teeth 107 of the second screw nut 108 is overcome and subsequently the screw 102 is further pushed in longitudinal direction L via the piston 114 for buildup of the clamping force between the mold halves. The force flux is hereby realized via the ring-shaped piston 114, via its central sleeve-shaped ram 116, its end surface 116a abutting the right end surface 106a of the second screw nut 106, via the distance ring 128, the thread teeth 107 of the second screw nut 108 onto the thread groove of the second thread 104 of the screw 102 and thus ultimately onto the screw 102 in the direction of the mold half. Hereby, the self-locking between the second screw nut 108 and the second thread 104 of the screw 102 is exploited for maintaining the clamping pressure.

While the second screw nut 108 moves in longitudinal direction L of the screw 102 relative to the first screw nut 106 for buildup of the clamping force, the first screw nut 106 is not subject to any load by the clamping force because the coupling elements between the end surfaces 106b and 108a of the screw nuts 106 and 108 are disposed with play in longitudinal direction L. The entire stroke of the piston/cylinder unit 113 is determined by the clearance S and the elasticity of the machine frame and thus amounts empirically to about 20 to 30 mm.

The piston 114 is relieved for decrease of the clamping pressure, and the self-locking connection between the second threaded screw 108 and the second thread 104 of the screw 102 is released by starting the not shown electric motor and the connected crown gear 117 via the belt 118. The axially movable first screw nut 106, which is axially movable in relation to the second screw nut 108 in longitudinal direction L, bears hereby upon a ring-shaped stop 129 arranged on the crown gear 117.

The spring elements 122 are so dimensioned as to yield at a force which is approximately 1.5 times the axial force required for the rapid stroke in order to move the screw 102 in longitudinal direction L.

FIG. 3 shows a schematic perspective illustration of a further embodiment of a linear drive device 101. This embodiment corresponds with respect to the piston/cylinder unit 113 and the second screw nut 108 with the previously described embodiment so that reference is made to the respective description. Same parts are provided with same reference numerals. In this embodiment, the screw 102 is advantageously configured as hollow shaft to increase the transmittable buckling forces. The first thread 103 is hereby arranged on a second screw 130 which is inserted into the hollow screw because a smaller screw diameter is sufficient as a consequence of the smaller forces for the rapid stroke. The first screw 102 is thus provided only with the second thread 104. In this solution of separate inventive importance, the first screw nut 106 is fixed to the end of the hollow screw 102, facing away from the platen 131. The torque connection between the driven second screw nut 108 and the second screw is realized by a shaft 132 extending in parallel relationship to the screws 102, 130. The shaft 132 is connected in the area of its ends via belt drives comprised of pulleys 133 and belts 134, on one hand, with the crown gear 117 on the second screw nut 108, and, on the other hand, with the end of the further screw 130, facing away from the screw 102. The further screw 130 is supported on the end distal to the housing 112 by a carrier 135 which is connected to the housing 112. In addition, a bearing 136 is disposed on the other end of the screw 130 for additional support of the further screw 130 in the hollow screw 102.

In this embodiment, the pitches of the screws 102, 130 can be selected differently as this can be compensated by the transmission ratio of the belt drives.

Although, the present invention has been described with reference to a so-called three-platen machine, the linear drive device can also be used for so-called two-platen machines which are then operated as pulling element rather than as push ram. In this case, four screws are normally provided in the corner points of an imaginary tetragon between the fixed platen and a moving platen. It is hereby possible, to arrange the driven screw nuts and the piston/cylinder unit on the fixed or moving platen. It is also possible to locally separate the twin-screw unit from the piston/cylinder unit, i.e. to arrange, for example, the piston/cylinder unit on a fixed platen and the twin-screw unit on a moving platen. The clamping force is then supplied via the screw of the second screw nut.

An embodiment of a linear drive device of a two-platen clamping unit will now be described with reference to FIGS. 4-9.

The clamping unit of an injection molding machine according to FIG. 4 includes a fixed platen, which is securely connected with the machine frame 1, and a moving platen 3, which is movably supported on the machine frame 1. The platens 2 and 3 are interconnected by four tie bars 4 and 5, whereby only both forward tie bars are visible in the illustration of FIG. 4. The ends of the tie bars 4, 5, arranged in the fixed platen 2, have pistons 6, 7 which are non-rotatably supported in cylinder spaces 8, 9 within the fixed platen 2. The hydraulic piston/cylinder units, arranged in the fixed platen 2, represent the clamping force unit for generating the clamping force SK. The pistons 6, 7 subdivide the cylinder spaces 8, 9 in closing-side cylinder spaces 8.1, 9.1 and opening-side cylinder spaces 8.2, 9.2, whereby the clamping force SK can be generated in the tie bars 4, 5, when the closing-side cylinder spaces 8.1 and 9.1 are acted upon by pressure medium via hydraulic lines 10, 11 of a hydraulic plant, not shown in more detail.

The platens 2, 3 carry molding halves 2.1 and 3.1. The moving platen 3 is shown in opening position by way of full lines and in closing position by way of dash-dot lines in which the molding halves 2.1, 3.1 touch one another.

The ends of the tie bars 4, 5, facing away from the fixed platen 2, are configured as screws 4.1, 5.1 and guided through the moving platen 3, wherein screw drives 12, 13 are mounted on the ends, projecting beyond the moving platen 3, and can be caused to rotate by an electric motor 15, secured to the moving platen 3, via a toothed belt 14.

FIG. 5 shows a half-section of the screw 4.1 with the screw drive 12, the toothed belt 14, the moving platen 3, the fixed platen 2, the tie bar 4, the piston 6 as well as the closing-side cylinder space 8.1, the opening-side cylinder space 8.2 and the hydraulic line 10.

The screw drive 12 includes essentially a first screw nut 16 (designated in the following only as “screw nut”) which is mounted to the screw 4.1, a second screw nut 17 (designated in the following as “rotary sleeve 17”) which is in engagement with the toothed belt 17, a support of the rotary sleeve 17 in the moving platen 3 by means of the bearings 18 and 19, a first spring assembly 20 acting between screw nut 16 and rotary sleeve 17, a second spring assembly 21 acting between the outer bearing support of the bearings 18, 19 and the moving platen 3, a force transmission element in the form of brake rings 22 and 33, respectively secured to the moving platen 3 and the rotary sleeve 17 and provided with conical friction surfaces 22.1 and 23.1, and engagement means in the form of a helix 24 or in the form of thread profiles (acme thread FIG. 8) switchable into forced engagement between rotary sleeve 17 and screw 4.1.

The screw nut 16 and the screw 4.1 have thread grooves in which balls 26 roll. The thread grooves 4.2 of the screw 4.1 may be single-thread or multi-thread and include interposed grooves 27 for the engagement means of the rotary sleeve 17. The balls 26 roll in the thread grooves of screw nut 16 and screw 4.1 substantially free from play so that a rotation of the screw nut 16 in relation to the non-rotatable screw 4.1 is always accompanied by a precise axial adjustment of the screw nut 16.

The rotary sleeve 17 is linked in fixed rotative engagement with the screw nut 16 and held in fixed position free from play also axially with respect to the screw nut 16 during the opening and closing movements implemented by the screw drive 12. This is realized by providing the rotary sleeve 17 on the left side with a fixed stop and supporting it on the right side via the first spring assembly 20 on the screw nut 16. The first spring assembly 20 remains incompressible when executing the opening and closing motions.

The rotary sleeve 17 is axially aligned in relation to the screw nut 16 such that the helix 24, which is held in the rotary sleeve 17, is retained in the groove 27 of the screw 4.1 completely free from play, for example at a clearance of 0.5 mm to both flanks of the groove 27. (see FIG. 5a). The freedom of contact ensures that the axial adjustment motions of the screw nut 16 can be transmitted via the rotary sleeve 17, without appreciable rotation resistances onto the moving platen 3.

The axial adjustment of the rotary sleeve 17 in relation to the screw nut 16 is implemented by the following devices and measures.

The rotary sleeve 17 is initially rotated in relation to the screw nut 16 such that the helix 24 retained in the rotary sleeve 17 contacts the right flank of the groove 27 of the screw 4.1. Subsequently, the rotary sleeve 17 is turned back again to such a degree in relation to the screw nut 16 that the helix 24 is again positioned to the groove 27 of the screw 4.1, for example at a clearance of 0.5 mm to both flanks of the groove 27. This relative rotary position between screw nut 16 and rotary sleeve 17 is fixed by a conical tension element 28 which can widen between rotary sleeve 17 and screw nut 16. The conical tension element 28 contacts hereby through firm frictional connection on a screw nut ring 16.1 in which the screw nut 16 is non-rotatably but axially movably supported by means of keyway 16.2 and fitted key 16.3.

As described above, the rotary sleeve 17 remains constantly in same axial position in relation to the screw nut 16 during the opening and closing motions, executed by the screw drive 12, because, on one hand, as a result of abutment of the stop 17.1 of the rotary sleeve 17 upon the left impact surface 16.4 of the screw nut, and, on the other hand, through abutment of the first spring assembly 20 upon the right impact surface 16.5 of the screw nut 16. The force of the first spring assembly 20 is adjusted in such a manner that the spring assembly is not pressed together by the mass forces, generated during travel of the moving platen 3 into closing position.

The rotary sleeve 17 is comprised of the sleeve elements 17.2 and 17.3 which surround the conical tension element 28 as well as the left and right impact surfaces 16.4, 16.5 of the screw nut 16. The sleeve element 17.3 is in engagement with the toothed belt 14. The rotary sleeve 18 includes further the brake ring 22.1, the bearing sleeve 17.4 and the nut 17.5. All components of the rotary sleeve 17 are connected in fixed rotative engagement.

The bearings 18 and 19 are fixed to the bearing sleeve 17.4 through intervention of an inner distance ring 29.

The bearings 18 and 19 are supported with their outer bearing rings through intervention of an outer distance ring 39 for axial displacement in the moving platen 3.

The outer bearing rings of the bearings 18 and 19 as well as the outer distance ring 30 represent the outer bearing support by which the rotary sleeve 17 is able to impact axially either on the second spring assembly 21 or on the second brake ring 23 which is connected to the moving platen 3. The second spring assembly 21 is supported in a flange ring 3.2 which is fixedly connected with the moving platen 3.

The clamping unit according to the invention operates as follows:

### 1. Opening of the Clamping Unit with the Screw Drive

Initiation of a rotation via the electric motor 15 and the toothed belt 14 into the screw drives 12, 13 causes the moving platen 3 with the molding half 3.1 to move from the closed position, shown in FIG. 1 by way of dash-dot lines, into the opening position, shown in full lines.

According to FIG. 5, the rotation introduced via the toothed belt 14 and the rotary sleeve 17 into the screw nut 16 results in an axial displacement of the screw nut 16 to the left or opening direction “0”. The rotary sleeve 17 is also moved to the left via the left impact surface 16.4 to thereby realize the force flux K₁, shown in FIG. 2 by way of dash-dot lines. This force flux is routed from the left impact surface 16.4 via the rotary sleeve 17 to the bearings 18 and 19 and from there via a sealing ring to the brake ring 23.1 which is fixedly connected to the moving platen 3. As the opening motion is initiated, the second spring assembly 21 relaxes and causes the conical friction surfaces 22.1 and 22.2 to move apart by the gap width B to thereby render the frictional engagement as a consequence of the preceding clamping pressure position no longer effective and to move the moving platen 3 from the freely rotating rotary sleeve 17 to the left into the opening position. The free ability of the rotary sleeve 17 to rotate is implemented by the afore-described axial positioning of the rotary sleeve 17 in relation to the screw nut 16 whereby the engagement means, here the helix 24, according to FIG. 5 are completely disengaged. Like in the subsequently described closing motion, the first and second spring assemblies 20, 21 are not compressed so as to realize, on one hand, the free rotating capability of the rotary sleeve 17 in relation to the screw 4.1, and, on the other hand, the decoupling of the conical friction surfaces 22.1 and 23.1.

### 2. Closing of the Clamping Unit with the Screw Drive

By operating the rotary drive of the screw nut 16 via the toothed belt 14 and the rotary sleeve 17 in opposite direction to the opening process, the rotary sleeve 17 is moved to the right or closing direction “S”, so as to realize the force flux K₂, as shown in FIG. 6 by way of dash-dot lines. The force flux is routed from the screw nut 16 via the right impact surface 16.5 and the first, still rigid spring assembly 20 to the rotary sleeve 17 and from there via the first and second bearings 18, 19 to the outer bearing support. From there, the second, also still rigid spring assembly 20 is moved to the right or in closing direction to thereby move the moving platen 3 via the flange ring 3.2 until reaching the closing position, shown in FIG. 4 by way of dash-dot lines, in which both mold halves 2.1 and 3.1 abut one another without clamping pressure. Also in this operational phase, the free rotation capability between rotary sleeve 17 and screw 4.1 according to FIG. 6a is maintained as a consequence of the axial positioning between screw nut 16 and rotary sleeve 17.

### 3. Generation of Clamping Pressure by the Clamping Pressure Unit

By admitting hydraulic pressure medium to act on the closing-side cylinder spaces 8.1, the piston 6, connected to the tie bar 4 and the screw 4.1, is moved to the right so that the mold halves 2.1 and 3.1, occupying the closing position, are pressed against one another by clamping pressure SK.

According to FIG. 7, the clamping force SK introduced via the piston 6 into the screw 4.1 causes at first the screw nut 17 to move slightly to the right as the first spring assembly 20 is compressed, so that the engagement means, here the helix 24 disposed in the rotary sleeve 17, fully engages the left flank of the groove 27, as shown in FIG. 7a. The displacement corresponds substantially to a gap width, as depicted in FIGS. 5a and 6a between the helix 24 and both flanks of the groove 27.

The initially adjusting slight axial displacement of the screw nut 16 in relation to the rotary sleeve 17 results in a first force flux K₃, as marked in dash-dot lines. In view of the fact that the screw 4.1 is in direct contact via the helix 24 with the rotary sleeve 17 according to FIG. 7a, the clamping force is introduced from the screw 4.1 directly into the rotary sleeve 17 and transmitted via the bearings 18 and 19 to the outer bearing support to the second spring assembly 21. As the second spring assembly 21 has a greater spring force than the first spring assembly 20, the second spring assembly 21 is compressed slightly staggered in time in relation to the compression of the first spring assembly 20, i.e. as a result of the compression of the first spring assembly 20, a direct axial forced engagement between screw 4.1 and rotary sleeve 17 is established and a first force flux K₃ is generated which causes subsequently the second spring assembly 21 to compress. The compression of the second spring assembly 21 is accompanied by a slight shift of the rotary sleeve 17 in relation to the moving platen 3 or the brake ring 23 so as to establish a fixed rotative engagement of the conical friction surface 23.1 with the conical friction surface 23.1 of the brake ring 22. In view of the fixed rotative engagement and direct forced engagement between screw 4.1, helix 24 (FIG. 7a), rotary sleeve 17, brake ring 22, brake ring 23 and moving platen 3, the second governing force flux K₄ (dashed double-dot line) is routed via the afore-described sequence of forced engagement.

Hereby it is important that the force flux for the significant static clamping forces is not routed via the screw drive 12 and its very slight ball contact areas but by a direct force flux from the hydraulic piston 6, the screw 4.1, the helix 24, the rotary sleeve 17, the brake ring 22, the brake ring 23 to the moving platen 3, while the screw drive 12 is automatically secured against reverse rotation (friction engagement by the conical friction surfaces 22.1 and 23.1). Unlike the extremely slight ball contact surface of the ball screw drive, the clamping pressure is effected in accordance with the invention across the long line contact area established by the helix 24.

When using instead of helices 24, interlocking thread profiles 25 of screw 16 and rotary sleeve 17 as engagement means, the line contact area can yet be significantly expanded. FIG. 8 shows a thread profile 25 in the form of an acme thread to realize an elongated, wide, helical contact area which is capable to withstand highest loads.

1. Linear drive device for opening and closing molding tools as well as applying a claming force thereon, in particular mold halves of a plastics molding machine, comprising a screw drive acting on the molding tools and having a first screw nut for opening and closing the molding tools, a screw, and a piston/cylinder unit acting on the molding tools for the application of the clamping force, characterized in that the piston/cylinder unit (113; 6, 8; 7, 9) acts on the molding tools via a second screw nut (108; 17).

2. Linear drive device according to claim 1, characterized in that the second screw nut (108; 17) is moved along the screw (102; 4, 5) during opening and closing of the molding tools via the first screw nut (106; 16) with little force, preferably freewheeling.

3. Linear drive device according to claim 1 or 2, characterized in that the screw (102) is fixedly connected in the form of a ram with the molding tool.

4. Linear drive device according to one of the claims 1 to 3, characterized in that the screw (102) has a thread (104) for the second screw nut (108), whose thread groove is wider than the width of the teeth (107) of the second screw nut (108).

5. Linear drive device according to one of the claims 1 to 4, characterized in that the screw (102) is double-threaded and has in addition to a thread (104) for the second screw nut (108) a further thread (103) for the first screw nut (106).

6. Linear drive device according to claim 5, characterized in that the first screw nut (106) is arranged on the screw (102) at a distance (a) next to the second screw nut (108), and the torque transmission is implemented between the first screw nut (106) and the second screw nut (108) via coupling elements (119), wherein the second screw nut (108) is movable on the screw (102) in longitudinal direction (L) thereof in relation to the first screw nut (106).

7. Linear drive device according to claim 6, characterized in that the coupling elements (119) are configured as pins, each of which having ends respectively inserted in bores (120, 121) in the confronting end surfaces (106a, 108a) of the first screw nut (106) and the second screw nut (108), wherein the depth of the bores (120, 121) and the length of the pins are so selected that the second screw nut (108) is movable in relation to the first screw nut (106) on the screw (102) in longitudinal direction (L) thereof.

8. Linear drive device according to claim 6 or 7, characterized in that the first screw nut (106) is supported via spring elements (122) on the second screw nut (108).

9. Linear drive device according to claim 8, characterized in that the spring elements (122) are configured as disc springs between the first screw nut (106) and the second screw nut (108).

10. Linear drive device according to one of the claims 1 to 4, characterized in that the screw (102) is configured as hollow shaft, the first screw nut (106) is arranged in fixed rotative engagement on one end of the screw (102), and a further screw (130) is guided through the first screw nut (106) into the screw (102) for opening and closing the molding tool.

11. Linear drive device according to claim 10, characterized in that the further screw (130) is connected via a shaft (132) in parallel relationship thereto and belt drives with the second screw nut (108) for torque transmission.

12. Linear drive device according to one of the claims 1 to 11, characterized in thattthe first screw nut (106) and the pertaining thread (103) are designed as ball screw drive, and the second screw nut (108) and the pertaining thread (104) are configured as flat screw drive, preferably as acme screw drive.

13. Linear drive device according to one of the claims 1 to 12, characterized in that the piston/cylinder unit (113) includes essentially a piston (114) and a cylinder space (115) in a housing (112), and the ring-shaped piston (114) has a sleeve-like ram (116) through which the screw (102) is guided.

14. Linear drive device according to claim 13, characterized in that the second screw nut (108) is supported adjacent to the sleeve-like ram (116) and via rolling-contact bearings (110) in a sleeve-like collar (111) arranged on the housing (112), wherein the second screw nut (108) is movable for transmission of the clamping force from the ram (116) onto the screw (102) in longitudinal direction (L) of the screw (102).

15. Linear drive device according to one of the claims 1 to 14, characterized in that a crown gear (117) is arranged on an end surface (108) of the second screw nut (108) for a drive for the second screw nut (108) via a belt (118) for opening and closing the molding tools.

16. Linear drive device according to one of the claims 1 to 15, characterized in that the piston/cylinder unit (113) can be driven hydraulically.

17. Linear drive device according to claims 1, 2, 4, 5, 8, 15 or 16, comprising at least one moving platen and a fixed platen (2, 3) as molding tools, several, preferably four, screw drives (12, 13), wherein each screw drive has a tie bar (4, 5) having an end extending through the moving platen (3) and configured as screw (4.1) and wherein in each screw drive
the tie bar (4, 5) is supported non-rotatably in the fixed platen (2),
the first screw nut (16) is linked in fixed rotative engagement with the second screw nut (17),
the second screw nut (17) has engagement means by which the second screw nut (17) can be connected directly and at long line contact with the screw (4.1), when building up the clamping pressure,
the second screw nut (17) is coupled with the rotary drive (14, 15),
the second screw nut (17) is supported in the moving platen (3) in bearings (18, 19) for axial displacement,
the second screw nut (17) is fixedly connected with a force transmission element which can be linked in fixed rotative engagement with a complementary force transmission element of the moving plate (3) through axial movement in relation to the moving platen (3),
the first screw nut (16) is axially supported on the second screw nut (17) on the side distal to the moving platen (3) via a fixed stop (16.4) and on the side proximal to the moving platen (3) via a first spring assembly (20),
a second spring assembly (21) is disposed between the outer bearing support of the bearings (18, 19), which is non-rotatably arranged in the moving platen (3), and the moving platen (3), and has a spring force which is greater than the spring fore of the first spring assembly (20),
the spring force of the first spring assembly (20) is determined subject to the condition that the first and second spring assemblies (20, 21) do not deform, when an opening or closing motion of the moving platen (3) is implemented via the screw drive (12, 13), wherein the second screw nut (17), upon impact on the fixed stop (16.4), on one hand, and impact on the non-deformed first spring assembly (20), on the other hand, is so positioned in relation to the first screw nut (16) that the engagement means of the second screw nut (17) disengage from the screw (4.1), and
the spring force of the second spring assembly (21) is determined subject to the condition that the first spring unit (20) is first compressed, when a clamping force SK, introduced via the screw (4.1), becomes effective, whereupon the second screw nut (17) is moved in relation to the first screw nut (16) that the engagement means of the second screw nut (17) are in full forced engagement with the screw (4.1) and subsequently the second spring assembly (21) is pressed together, resulting in an axial displacement of the second screw nut (17) in relation to the moving platen (3) accompanied by a fixed rotative coupling of the force transmission elements.

18. Linear drive device according to claim 17, characterized in that the engagement means of the second screw nut (17) are comprised of a helix (24) which is disposed in helical grooves of the second screw nut (17) and which can be shifted through axial adjustment of the second screw nut (17) in relation to the first screw nut (16) in full forced engagement or in contactless manner with the thread grooves (27).

19. Linear drive device according to claim 17, characterized in that the engagement means of the second screw nut are comprised of interlocking thread profiles (25) of the second screw nut (17), on one hand, and the screw (4.1), on the other hand.

20. Linear drive device according to claim 19, characterized in that the thread profiles (25) of the second screw nut (17) and screw (4.1) interlock in the form of an acme thread.

21. Linear drive device according to claim 19, characterized in that the thread profiles (25) of the second screw nut (17) and screw (4.1) interlock in the form of a buttress thread.

22. Linear drive device according to one of the claims 17 to 21, characterized in that the screw drive (12, 13) is a ball screw drive.

23. Linear drive device according to claim 17, characterized in that the first screw nut (16) and the engagement means of the second screw nut (17) are in engagement with the same thread grooves of the screw (4.1).

24. Linear drive device according to one of the claims 17 to 23, characterized in that the device for non-rotatable axial positioning or adjustment of the second screw nut (17) in relation to the first screw nut (16) includes a conical tension element (28) by which a screw nut ring (16.1) is connectable in fixed rotative engagement with the second screw nut (17) and in which the first screw nut (16) is held non-rotatably and axially movable by means of keyway (16.2) and fitted key (16.3).

25. Linear drive device according to one of the claims 17 to 24, characterized in that the force transmission elements are brake rings (22, 23) with conical friction surfaces (22.1, 23.1).

26. Linear drive device according to one of the claims 17 to 25, characterized in that hydraulic piston/cylinder units (6, 8) are disposed in the fixed platen (2), with the ends of the tie bars (4) having pistons (6) for arrangement in cylinder spaces (8, 9) of the fixed platen (2).

27. Linear drive device according to one of the claims 17 to 25, characterized in that the clamping force unit is comprised of a split moving or fixed platen, with a hydraulic pressure pad in the form of one or more hydraulic pressure elements arranged between a mold carrier plate and a support plate.

28. Plastics molding machine with a linear drive device according to one of the preceding claims.
